(19) United States
(12) Patent Application Publication
(10) Pub. No.: US 2012/0036573 A1
(43) Pub. Date: Feb. 9, 2012

(54) Drag-and-Tag Authentication

(75) Inventor: Feng-Yuan Yang, Taipei County (TW)

(73) Assignee: Feng-Yuan Yang, Taipei County (TW)

(21) Appl. No.: 13/034,977

(22) Filed: Feb. 25, 2011

(30) Foreign Application Priority Data
Aug. 5, 2010 (TW) 099214949

(51) Int. Cl. H04L 9/32

(52) U.S. Cl. 726/16

(57) ABSTRACT

A drag-and-tag authentication apparatus includes an electronic device, a setting mechanism and an authentication mechanism. The electronic device includes a processor, a display electrically connected to the processor, an operation unit electrically connected to the processor, and a power supply electrically connected to the processor. The setting mechanism is electrically connected to the processor and includes first and second selection units operable for selecting literal and graphic items. The authentication mechanism is electrically connected to the processor and includes literal items and graphic items. Some of the literal items can be located and define a polygonal region. Some of the graphic items can be located and covered by the polygonal region for authentication.

### BACKGROUND OF INVENTION

1. Field of Invention

The present invention emphasizes on a drag-and-tag authentication. Particularly focus on a drag-and-tag authentication that is capable of ensuring login security and avoiding unfriendly attacks and dictionary attacks.

2. Pioneer Technique

Login authentication is widely used and is indispensible for security. Entering a personal identification number (“PIN”) to log in an automatic teller machine (“ATM”) or a cyber bank. Entering a password to log in a personal computer. Selecting an icon into an electronic device and writing a word or drawing on a picture to log in a touch panel are examples that involve the application of login authentication.

In a traditional login system, users have to provide accounts and passwords in order to login an electronic device in a secured environment. In addition, users login into their accounts by entering their passwords through a physical keyboard, a virtual keyboard, a touch panel or a mouse. Although the login processes are known to be in a protected and secured environment, these manners are however vulnerable to unfriendly recording via unavoidable attacks such as a monitor program implanted in the electronic device or a camera located near the electronic device. The account information and passwords could be stolen and used to cause damages of the finance of the user. Moreover the tendency of using small electronic devices such as cell phones, PDAs and tablet computers make virtual keyboards impractical. Should such a small electronic device be equipped with a virtual keyboard, it would be too small for a user to operate to log in. There is a need for a drag-and-tag login.

The present invention is therefore intended to obviate or at least alleviate the problems encountered in pioneer technique.

In order to prevent the identity or money from being stolen and to keep away from inconvenience of using virtual keyboards in small device, the invention with improved login authentication becomes prominent and essential.

The invention repeating here can replace the traditional login system and exclude the risks of identity being stolen.

### SUMMARY OF INVENTION

The purpose of this invention is to provide a secured and reliable login that resists unfriendly recording and dictionary attacks to further reduce the risks of passwords being stolen.

To achieve the goal, the drag-and-tag authentication apparatus includes an electronic device, a setting mechanism and an authentication mechanism. The electronic device includes a processor, a display electrically connected to the processor, an operation unit electrically connected to the processor, and a power supply electrically connected to the processor. The setting mechanism is electrically connected to the processor and includes first and second selection units that are operable for selecting literal and graphic items. The authentication mechanism is electrically connected to the processor and includes literal and graphic items. Some of the literal items can be located and define a polygonal region. Some of the graphic items can be located and covered by the polygonal region for authentication.

The electronic device can be a computer, a personal digital assistant or a cell phone.

In an embodiment, the electronic device includes a shell containing the processor, the display, the operation unit and the power supply.

In an embodiment, the display is a screen.

In an embodiment, the operation unit includes a plurality of buttons.

In an embodiment, the display is combined with the operation unit, thus forming a touch panel.

In an embodiment, the first selection unit includes a plurality of literal items, and the second selection unit includes a plurality of graphic items.

In an embodiment, the first selection unit includes a plurality of literal and graphic items, and the second selection unit includes a plurality of literal and graphic items.

Each of the literal items shows a number, a letter, a character or a symbol.

Each of the graphic items shows a simple geographic shape, a picture, a pattern or a sign.

Other objectives, advantages and features of the present invention will be presented from the following description referring to the attached drawings.

### BRIEF DESCRIPTION OF DRAWINGS

The present invention will be described via detailed illustration of the preferred embodiment referring to the drawings wherein:

FIG. 1 is a perspective view of a drag-and-tag authentication apparatus according to the preferred embodiment of the present invention;

FIG. 2 is a block diagram of the drag-and-tag authentication apparatus shown in FIG. 1;

FIGS. 3 and 4 show a process for setting a numeric password with the drag-and-tag authentication apparatus shown in FIG. 1;

FIGS. 5 and 6 show a process for setting a graphic password with the drag-and-tag authentication apparatus shown in FIG. 1; and

FIGS. 7 to 12 show a process for authenticating the numeric and graphic passwords set in the processes shown in FIGS. 3 through 6.

### DETAILED DESCRIPTION OF PREFERRED EMBODIMENT

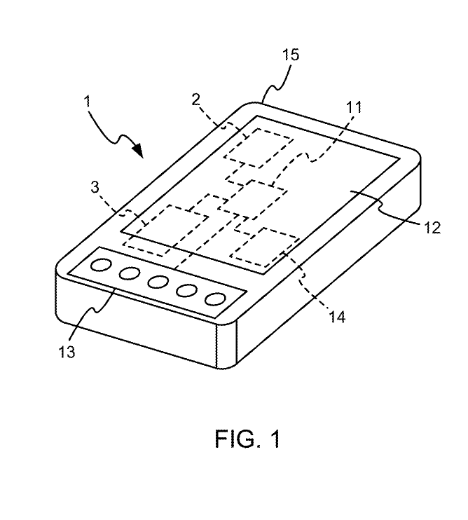

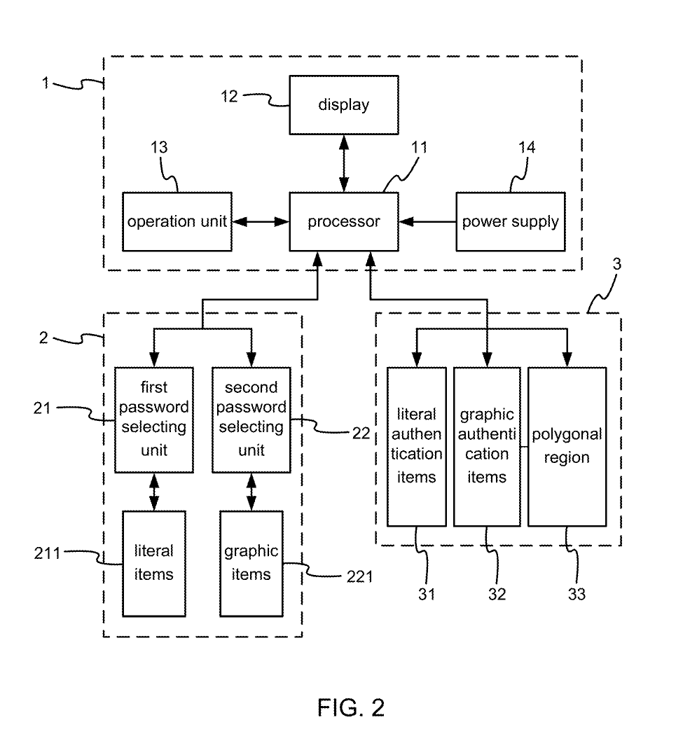

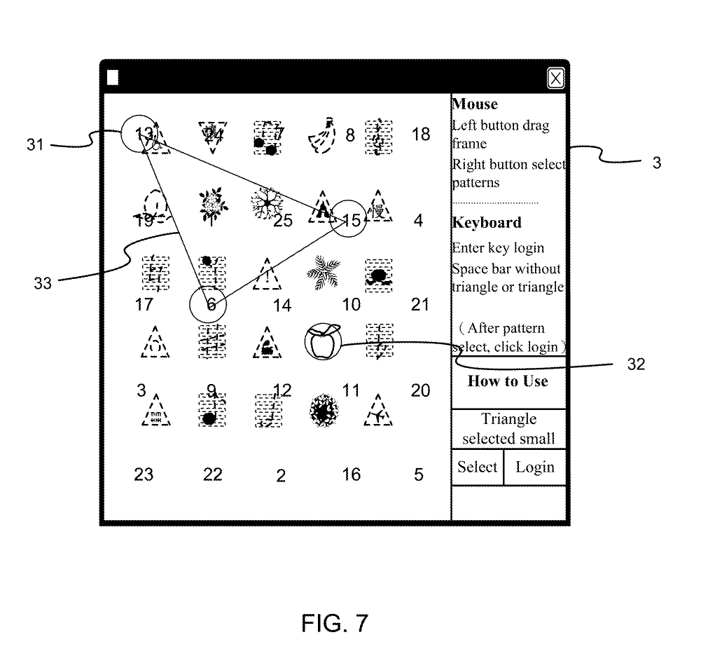

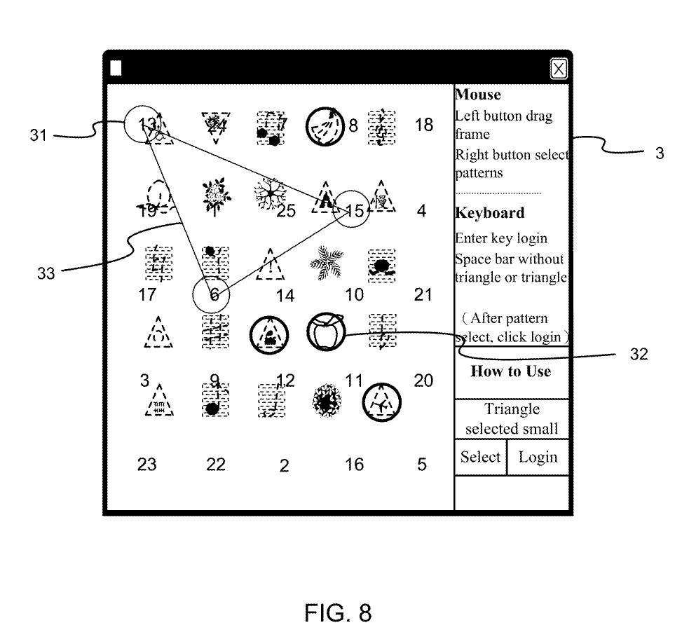

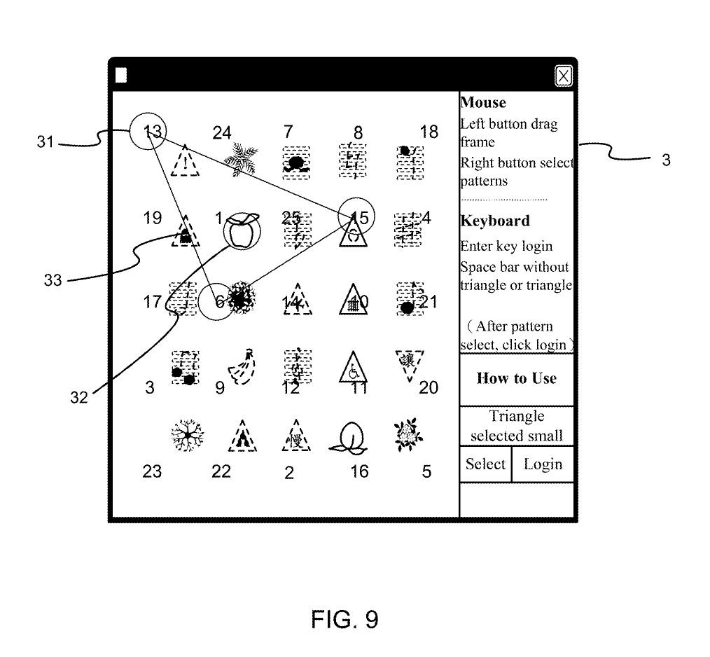

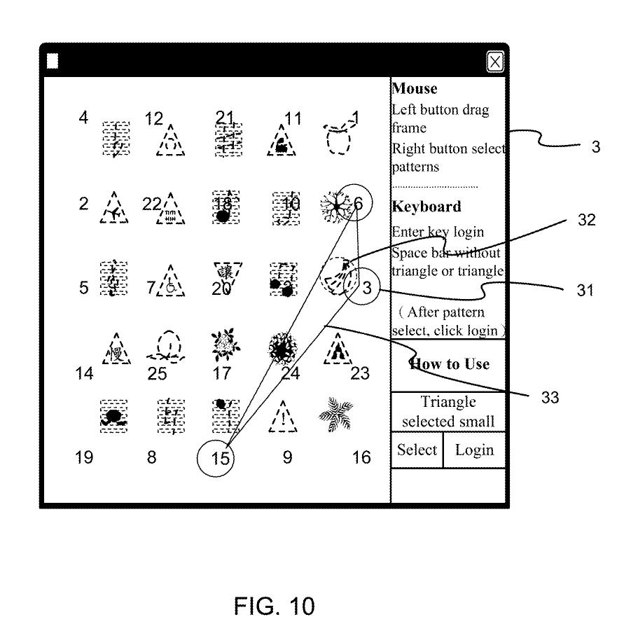

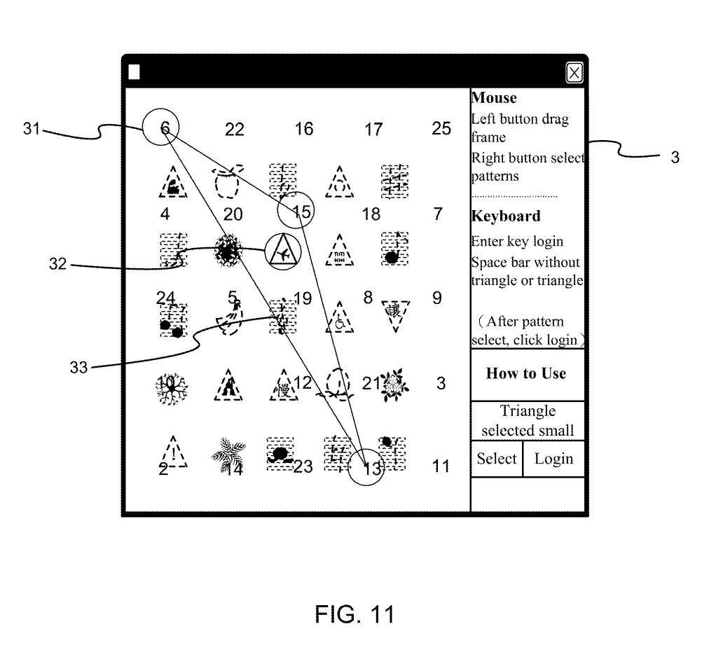

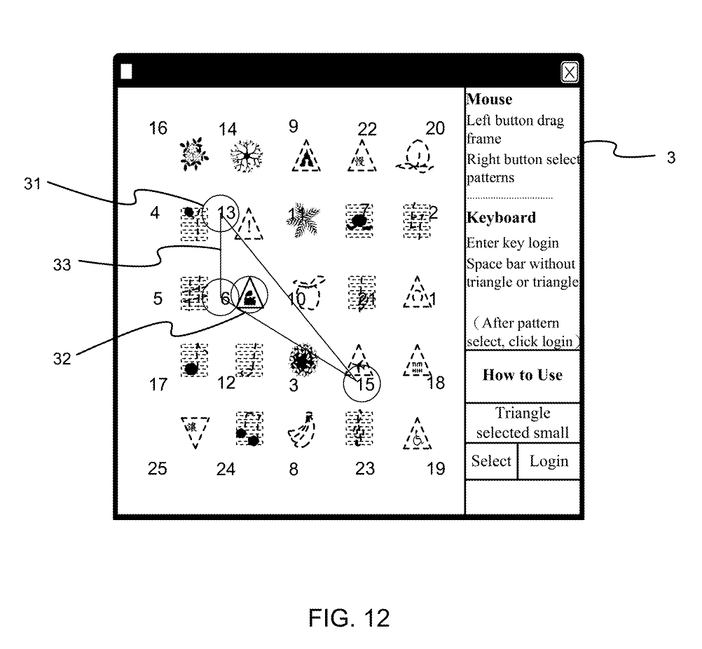

Referring to FIGS. 1 through 12, a drag-and-tag authentication apparatus includes an electronic device 1, a setting mechanism 2 and an authentication mechanism 3 according to the preferred embodiment of the present invention.

The electronic device 1 can be a computer, a PDA or a cell phone for example. The electronic device includes a processor 11, a display 12, an operation unit 13, a power supply 14 and a shell 15. The processor 11 is electrically connected to the display 12, the operation unit 13 and the power supply 14. The processor 11, the display 12, the operation unit 13 and the power supply 14 are located in the shell 15. The display 12 is preferably a screen. The operation unit 13 can be a keypad including buttons 16 or a touch pad (or “track pad”) including virtual buttons. In an alternative embodiment, the operation unit 13 can be combined with the display 12, thus forming a touch panel (or “touch screen”) in another embodiment.

The setting mechanism 2 is electrically connected to the processor 11. The setting mechanism 2 includes a first password selecting unit 21 and a second password selecting unit 22. The first password selecting unit 21 is operable for selecting letters, characters, symbols or numbers. Preferably, the first password selecting unit 21 includes a plurality of literal items 211. Each of the literal items 211 provides a letter, character, symbol or number. The literal items 211 can be arranged in a sequence or randomly.

The second password selecting unit 22 is operable for selecting pictures or patterns. The second password selecting unit 22 includes a plurality of graphic items 221. Each of the graphic items 221 provides a simple geographic shape, a pattern or a picture.

The authentication mechanism 3 is connected to the processor 11 electrically. The authentication mechanism 3 includes alternately arranged literal authentication items 31 and graphic authentication items 32. Each of the literal authentication items 31 provides a letter, character, symbol or number similar to that is provided by a related one of the literal items 211. The literal authentication items 31 can be arranged in a sequence or randomly. Some of the literal authentication items 31 can be selected and put together to define a polygonal region 33.

Each of the graphic authentication items 32 provides a simple geographic shape, a pattern or a picture similar to that is provided by a related one of the graphic items 221. Selected one of the graphic authentication items 32 can be dragged into the polygonal region.

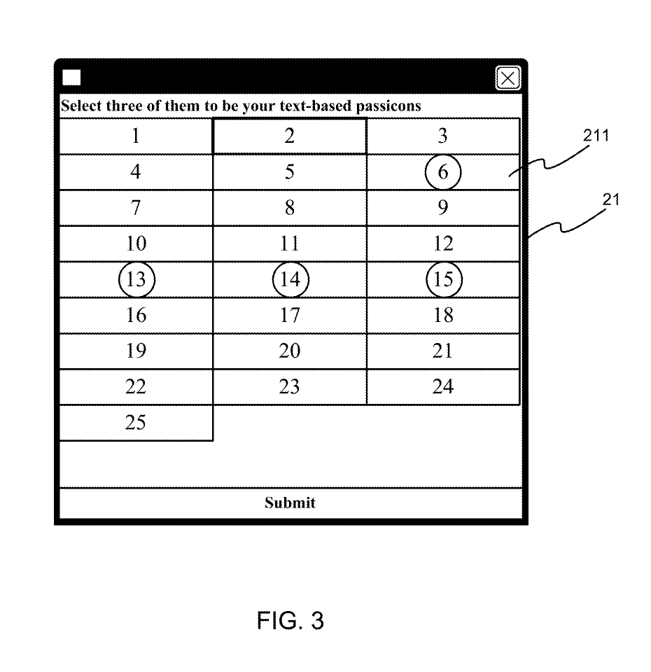

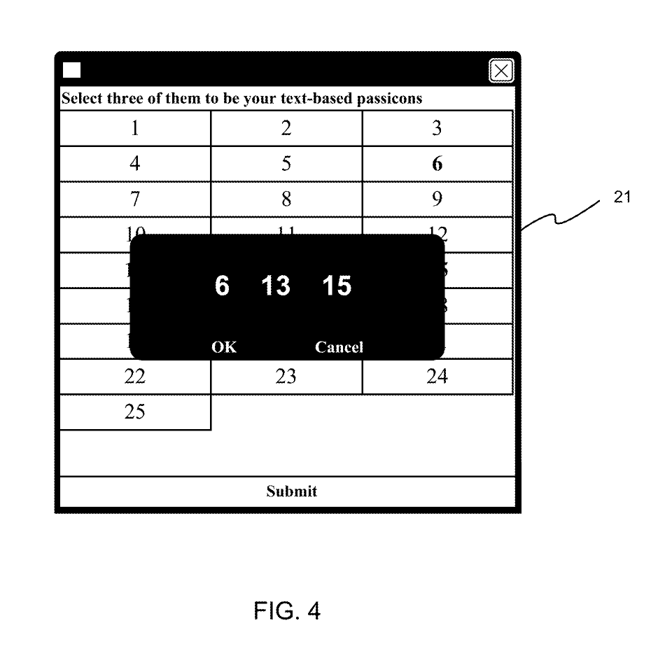

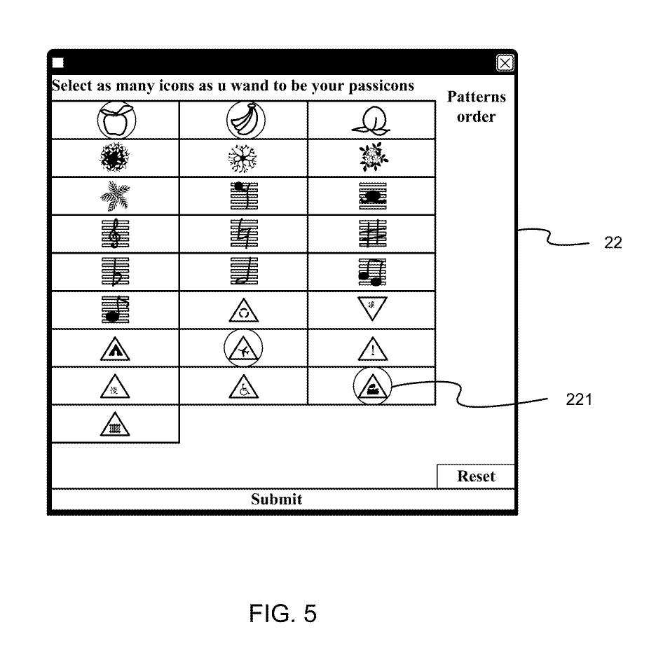

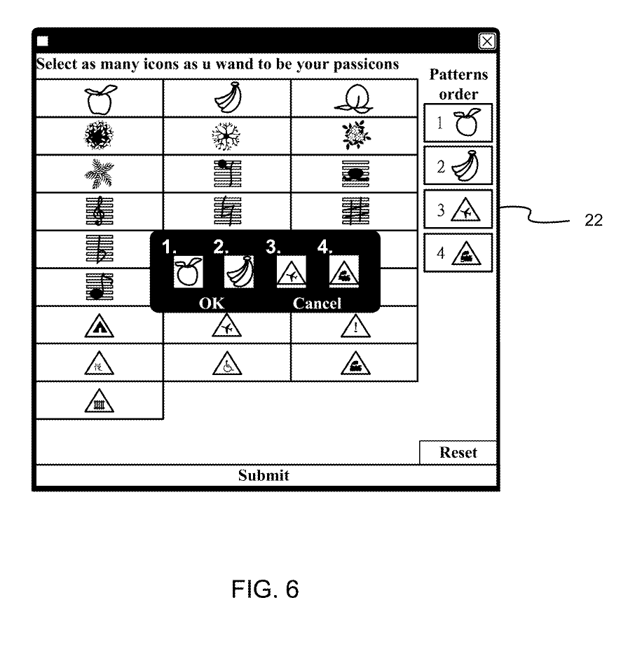

In operation, the electronic device 1 is energized by the power supply 14. The processor 11, the display 12 and the operation unit 13 are used together to show the setting mechanism 2 and the authentication mechanism 3. Thus, a user is allowed to use the literal items 211 of the first selection unit 21 and the graphic items 221 of the second selection unit 22 to execute initial setting. For example, the user selects “6”, “13” and “15” and confirms the selection as shown in FIGS. 3 and 4. The user selects pictures of apple and banana and signs of “Beware of airplanes” and “Beware of trains” and confirms the selection as shown in FIGS. 5 and 6.

After the setting, when the user logs in again, the user has to use the literal authentication items 31 to locate “6”, “13” and “15” that he or she has selected through the first selection unit 21, and define a polygonal region 33 with the numbers. The polygonal region 33 can be shown or concealed. Then, the user uses the graphic authentication items 32 to locate the pictures of apple and banana and the signs of “Beware of airplanes” and “Beware of trains” that he or she has selected via the second selection unit 22, and drag the selected pictures and signs into the polygonal region 33 for authentication. Every time a selected picture or sign is dragged into the polygonal region 33, the polygonal region 33 is changed, i.e., the literal items 31 are rearranged.

In the preferred embodiment, the user drags the selected pictures and signs into the polygonal region 33 for authentication. However, in another embodiment, the user may alternatively drag the polygonal region to cover the selected pictures and signs for authentication.

In the preferred embodiment, the first selection unit 21 includes a plurality of literal items 211, and the second selection unit 22 includes a plurality of graphic items 221. However, in another embodiment, the first selection unit 21 can include a plurality of literal items 211 and graphic items 221, and the second selection unit 22 includes a plurality of literal items 211 and graphic items 221.

As described above, the drag-and-tag authentication apparatus can resist unfriendly recording and dictionary attacks. Thus, the drag-and-tag authentication apparatus improves login security.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

Any invention that is either simply modified or manipulated of the basic idea of the invention presented here should be considered as the application of the claim, not a new discovery.

1. A drag-and-tag authentication apparatus including:
an electronic device 1 including a processor 11, a display 12 electrically connected to the processor 11, an operation unit 13 electrically connected to the processor 11, and a power supply 14 electrically connected to the processor 11;
a setting mechanism 2 electrically connected to the processor 11 that includes first and second selection units 21, 22 operable for selecting literal and graphic items 211, 221; and
an authentication mechanism 3 electrically connected to the processor 11 and including literal items 31 and graphic items 32, wherein some of the literal items 31 can be located and define a polygonal region 33, wherein some of the graphic items 32 can be located and covered by the polygonal region 33 for authentication.

2. The drag-and-tag authentication apparatus according to claim 1, wherein the electronic device 1 is selected from the group consisting of a computer, a personal digital assistant and a cell phone.

3. The drag-and-tag authentication apparatus according to claim 1, wherein the electronic device 1 includes a shell 15 containing the processor 11, the display 12, the operation unit 13 and the power supply 14.

4. The drag-and-tag authentication apparatus according to claim 1, wherein the display 12 is a screen.

5. The drag-and-tag authentication apparatus according to claim 1, wherein the operation unit 13 includes a plurality of buttons 16.

6. The drag-and-tag authentication apparatus according to claim 1, wherein the display 12 is combined with the operation unit 13, thus forming a touch panel.

7. The drag-and-tag authentication apparatus according to claim 1, wherein the first selection unit 21 includes a plurality of literal items 211.

8. The drag-and-tag authentication apparatus according to claim 7, wherein each of the literal items 211 shows an item selected from a number, a letter, a character and a symbol.

9. The drag-and-tag authentication apparatus according to claim 1, wherein the first selection unit 21 includes a plurality of literal items 211 and a plurality of graphic items 221.

10. The drag-and-tag authentication apparatus according to claim 1, wherein the second selection unit 22 includes a plurality of graphic items 221.

11. The drag-and-tag authentication apparatus according to claim 10, wherein each of the graphic items 221 shows an item selected from a simple geographic shape, a picture, a pattern or a sign.

12. The drag-and-tag authentication apparatus according to claim 1, wherein the second selection unit 22 includes a plurality of literal items 211 and a plurality of graphic items 221.
